(19) United States
(12) Patent Application Publication
(10) Pub. No.: US 2008/0123875 A1
(43) Pub. Date: May 29, 2008

(54) AUDIO DEVICE PROTECTION SYSTEM

(75) Inventors: Weesyk Wang, Taipei (TW); Michael Yang, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/566,164

(22) Filed: Dec. 1, 2006

(30) Foreign Application Priority Data
Jun. 2, 2006 (TW) 095119548

(51) Int. Cl. H02B 1/00

(52) U.S. Cl. 381/123

(57) ABSTRACT

An audio device protection system for use in an electronic device electrically connecting to an audio device is disclosed. The electronic device outputs an audio signal, a power on/off signal, and a trigger signal. The audio device protection system includes a switching unit electrically connected to the audio signal and the audio device and a control unit electrically connected to the trigger signal and the switching unit. The control unit outputs, upon receipt of the trigger signal, a control signal to control electrical connection/disconnection of the audio signal to/from the audio device by the switching unit, thus controlling timing of delivery of the electronic device-outputted audio signal to the audio device during a startup/shutdown procedure of the electronic device. Accordingly, switching on/off a power of the electronic device does not generate audio noise which may otherwise instantaneously trigger or shut down the audio device to the detriment thereof.

### BACKGROUND OF THE INVENTION

1. Field of the Invention

The present invention relates to audio device protection systems, and more particularly, to an audio device protection system for preventing power switching of an electronic device from outputting audio noise which may otherwise instantaneously trigger or shut down an audio device to the detriment thereof.

2. Description of the Prior Art

Electronic devices (such as personal computer and notebook computer) acquire additional recreational functionalities, for example, playing media files (like audio files), when connected to an audio device.

FIG. 1A shows a circuit for a conventional embodiment of electrical connection between a notebook computer and an audio device, wherein the notebook computer comprises an audio signal-specific codec 10 outputting the audio signal (AUDIO_L/AUDIO_R) electrically connected to the audio device 11. As shown in the drawing, the codec 10 is equipped with blocking capacitors C433 and C435 (such that high-frequency blocking current passes the codec 10 before the codec 10 outputs any audio signal), in order to enhance the audio functionalities of the audio device.

Once a user switches on/off the notebook computer (for example, by pressing a power button), the notebook computer outputs a power on/off signal to connect/disconnect the notebook computer to/from a power supply. However, owing to the charging/discharging feature of the blocking capacitors C433 and C435, instantaneous charging/discharging happens to the audio signal (AUDIO_L/AUDIO_R) the moment the power is switched on/off. Referring to FIG. 1B, which is a schematic view of the relationship between the audio signal (AUDIO_L/AUDIO_R) and the power on/off signal (POWER) of the notebook computer, switching on/off the notebook computer generates an audio jump signal, which is also referred to as audio noise. The audio noise instantaneously triggers or shuts down the audio device and thereby causes the audio device to produce pop noise. The instantaneous triggering or shutting down of the audio device may damage the audio device or affect the audio device's life. In addition, pop noise produced by the audio device causes the user to wrongly believe that the audio device or the notebook computer has got trouble, or that the audio functionalities of the audio device or the audio output functionalities of the notebook computer are poor, thus unnecessarily bothering the user and causing the user to grumble.

Accordingly, an issue that needs an urgent solution is related to endeavors to provide a protection system for preventing power switching of an electronic device from generating audio noise which may otherwise instantaneously trigger or shut down an audio device to the detriment thereof.

### SUMMARY OF THE INVENTION

In light of the aforesaid drawbacks of the prior art, it is a primary objective of the present invention to provide an audio device protection system for use in an electronic device connected to an audio device so as to prevent power switching of the electronic device from generating audio noise which may otherwise instantaneously trigger or shut down the audio device to the detriment thereof.

Another objective of the present invention is to provide an audio device protection system for preventing an audio device from producing pop noise which may otherwise annoy a user and bring about the user's discontent.

In order to achieve the above and other objectives, the present invention provides an audio device protection system for use in an electronic device electrically connected to an audio device, wherein the electronic device outputs an audio signal, a power on/off signal, and a trigger signal, the audio signal allowing the audio device to operate, the trigger signal lagging the power on/off signal in changing from a first level to a second level different from the first level during a startup procedure of the electronic device, the trigger signal leading the power on/off signal in changing from the second level to the first level during a shutdown procedure of the electronic device. The audio device protection system comprises a switching unit and a control unit. The switching unit is electrically connected to the audio signal of the electronic device and the audio device and configured to enable/disable electrical connection therebetween. The control unit is electrically connected to the trigger signal of the electronic device and the switching unit and configured to output, upon receipt of the trigger signal outputted by the electronic device during the startup/shutdown procedure thereof, a control signal to the switching unit so as to allow the switching unit to enable/disable the electrical connection between the audio signal of the electronic device and the audio device, thus controlling timing of delivery of the electronic device-outputted audio signal to the audio device during the startup/shutdown procedure of the electronic device.

A preferred embodiment of the present invention discloses as follows: the electronic device is a notebook computer; the first level is a low potential, while the second level is a high potential; the trigger signal is a signal PCI_RESET outputted by chips of the electronic device; the switching unit is a switching circuit comprising a metal oxide semiconductor (MOS) component; the control unit is a control circuit comprising a metal oxide semiconductor (MOS) component; the control unit further comprises a delay circuit comprising a resistance component and a capacitance component, the delay circuit delays the control signal for a period of time relative to the trigger signal, wherein a delay caused by the delay circuit takes as much time as charging of the resistance component and the capacitance component does.

Unlike the prior art, the present invention discloses the audio device protection system which comprises the control unit for converting the trigger signal to the control signal, wherein the trigger signal lags/leads the power on/off signal in changing from the first/second level to the second/first level during the startup/shutdown procedure. As a result, the switching unit enables/disables the electrical connection between the audio signal and the audio device, thus controlling timing of delivery of the electronic device-outputted audio signal to the audio device during the startup/shutdown procedure of the electronic device. Accordingly, the present invention prevents an audio jump signal (audio noise) which may otherwise be outputted by an audio signal of an electronic device because of instantaneous charging/discharging of blocking capacitors when the power of the electronic device is switched on/off. The audio jump signal, if existed, would instantaneously trigger or shut down the audio device to the detriment thereof. Insomuch as the present invention prevents the audio jump signal which may otherwise be outputted by the audio signal when the power of the electronic device is switched on/off, the audio device does not produce audio noise, for example, pop noise, thus the user is not annoyed or dissatisfied with any audio noise.

### BRIEF DESCRIPTION OF THE DRAWINGS

FIG. 1A shows a circuit for a conventional embodiment of electrical connection between a notebook computer and an audio device;

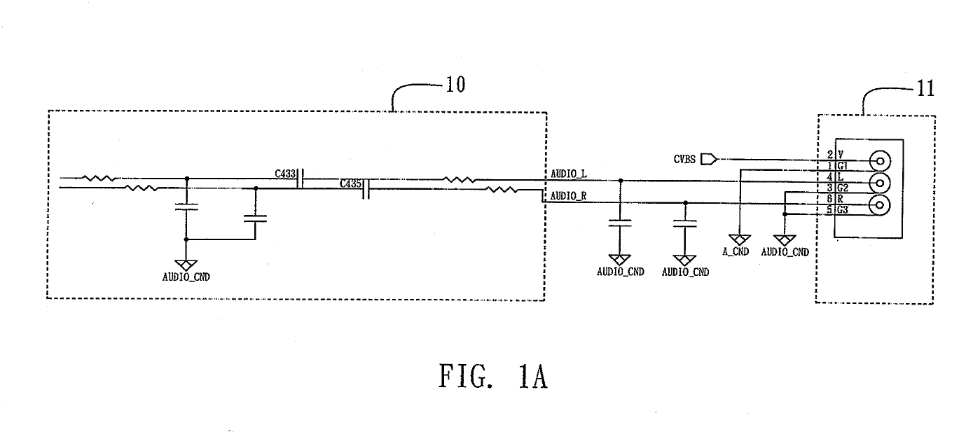

FIG. 1B is a schematic view of the relationship between the audio signal and the power on/off signal of the notebook computer shown in FIG. 1A;

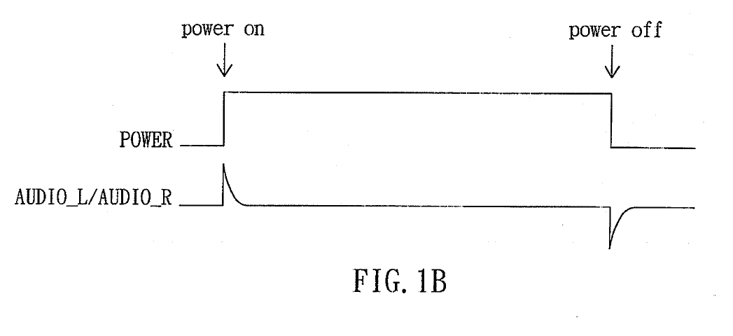

FIG. 2A is a schematic view of the basic structure of an audio device protection system in accordance with the present invention;

FIG. 2B shows a specific circuit for application of an audio device protection system to a notebook computer in accordance with the present invention; and

FIG. 2C is a schematic view of the relationships between a trigger signal, a control signal, an audio signal, an audio output signal, and the power on/off signal of the notebook computer shown in FIG. 2B.

### DETAILED DESCRIPTION OF THE EMBODIMENTS

The present invention is herein illustrated with a specific embodiment, so that one skilled in the pertinent art can easily understand other advantages and effects of the present invention from the disclosure of the invention.

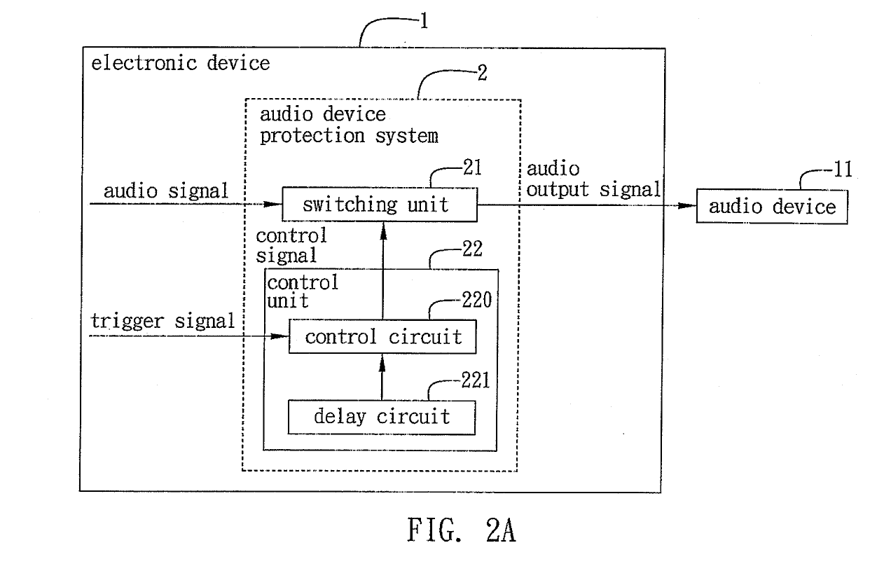

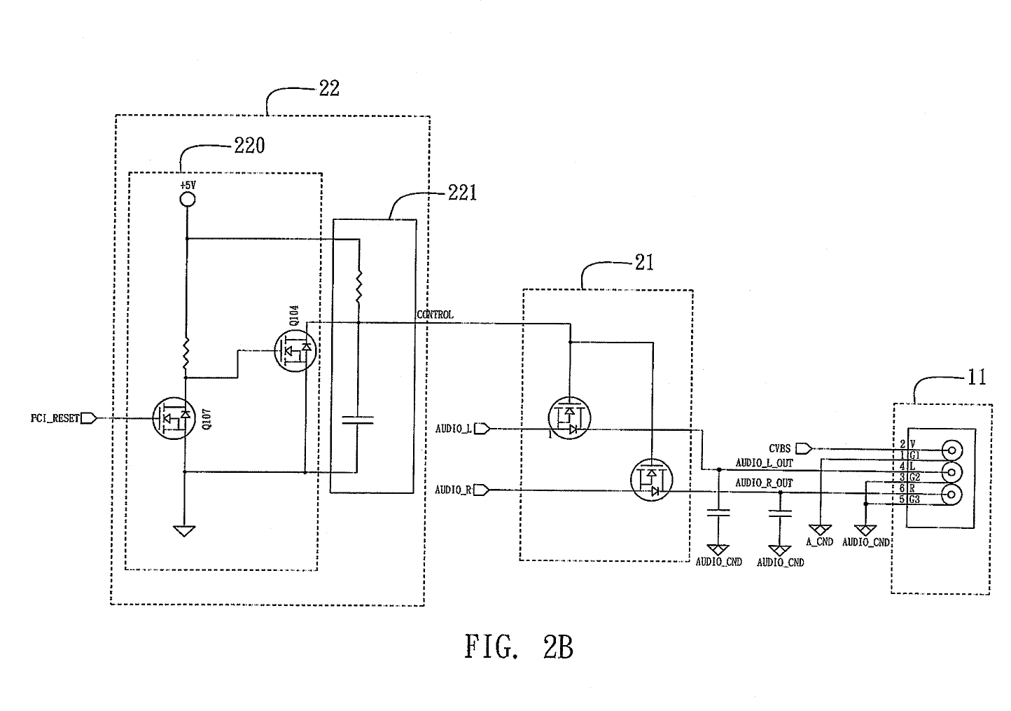

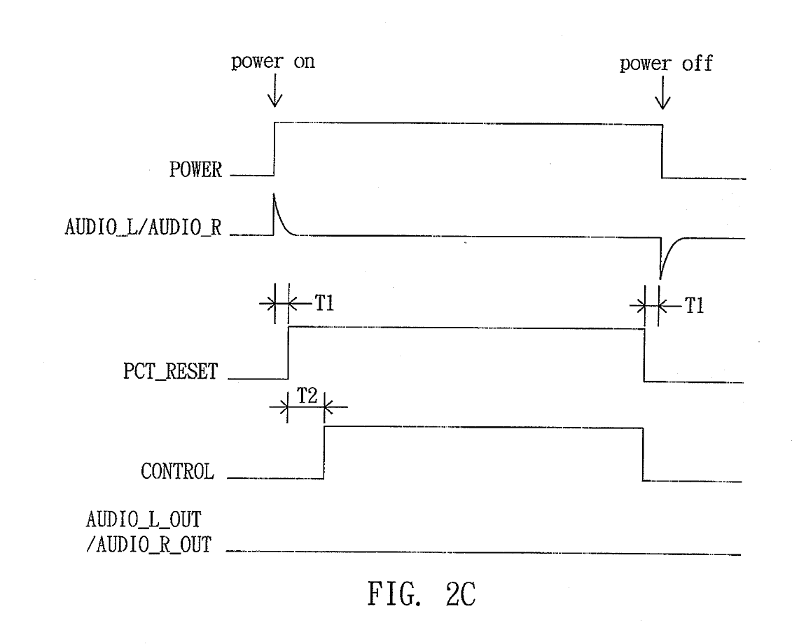

Refer to FIG. 2A, which is a schematic view of the basic structure of an audio device protection system 2 in accordance with the present invention. As shown in the drawing, the audio device protection system 2 of the present invention is to be used in an electronic device 1 electrically connected to an audio device 11. The electronic device 1 comes in the form of a notebook computer, person computer, and TV, though this embodiment is illustrated with a notebook computer. The electronic device 1 outputs an audio signal, a power on/off signal, and a trigger signal. The audio signal allows the audio device 11 to operate. The power on/off signal connects/disconnects the electronic device 1 to/from a power supply. When a user powers on the electronic device 1, the electronic device 1 executes a startup procedure, during which the trigger signal lags the power on/off signal in changing from a first level (a low potential for example) to a second level (a high potential for example) different from the first level. On the other hand, when the user powers off the electronic device 1, the electronic device 1 executes a shutdown procedure, during which the trigger signal leads the power on/off signal in changing from the second level to the first level. The trigger signal is a signal PCI_RESET outputted by chips of the electronic device 1.

As shown in FIG. 2A, the audio device protection system 2 of the present invention comprises a switching unit 21 and a control unit 22.

The switching unit 21 is electrically connected to the audio signal of the electronic device 1 and the audio device 11 and configured to enable/disable electrical connection therebetween. In this embodiment, the switching unit 21 is a switching circuit comprising switch-like metal oxide semiconductor (MOS) components.

The control unit 22 is electrically connected to the trigger signal of the electronic device 1 and the switching unit 21 and configured to output, upon receipt of the trigger signal outputted by the electronic device 1 during a startup/shutdown procedure thereof, a control signal to the switching unit 21 so as to allow the switching unit 21 to enable/disable the electrical connection between the audio signal of the electronic device 1 and the audio device 11, thus controlling timing of delivery of the audio signal (outputted by the electronic device 1) to the audio device 11 during the startup/shutdown procedure of the electronic device 1. In this embodiment, the control unit 22 comprises a control circuit 220 and a delay circuit 221. The control circuit 220 further comprises metal oxide semiconductor (MOS) components. The delay circuit 221 further comprises a resistance component and a capacitance component. The delay circuit 221 delays the control signal for a period of time relative to the trigger signal. A delay caused by the delay circuit 221 takes as much time as charging of the resistance component and the capacitance component does.

A preferred circuit of the audio device protection system 2 of the present invention is hereinafter illustrated with FIGS. 2B and 2C, regarding connections between various components of the preferred circuit and principles thereof.

Referring to FIG. 2B which shows a specific circuit for application of an audio device protection system to a notebook computer in accordance with the present invention. The switching unit 21 is a switching circuit comprising n-channel metal oxide semiconductor (NMOS) components Q105 and Q106. The NMOS components have the following functionalities. If NMOS gate receives a high-level signal, current between source and drain will be switched on. Conversely, if NMOS gate receives a low-level signal, current between source and drain will be switched off. The source of the NMOS component Q105 receives the audio signal AUDIO_L outputted by the notebook computer. The drain of the NMOS component Q105 is connected to the audio device 11. The source of the NMOS component Q106 receives the audio signal AUDIO_R outputted by the notebook computer. The drain of the NMOS component Q106 is connected to the audio device 11. If the control signal CONTROL received by the gates of the NMOS components Q105 and Q106 is a high-level signal, the notebook computer will output the audio signal AUDIO_L/AUDIO_R to the audio device 11, or, in other words, the audio signal AUDIO_L/AUDIO_R outputted by the notebook computer is electrically connected to the audio device 11.

The control unit 22 comprises a control circuit 220 and a delay circuit 221. The control circuit 220 comprises n-channel metal oxide semiconductor (NMOS) components Q104 and Q107. The delay circuit 221 comprises a resistance component R823 and a capacitance component C1217. The gate of the NMOS component Q107 receives the trigger signal PCI_RESET outputted by the notebook computer. The relationship between the trigger signal PCI_RESET and the power on/off signal for switching on/off the notebook computer (that is, connecting/disconnecting the notebook computer to/from the power) is depicted in FIG. 2C and explained later. The source of the NMOS component Q107 is connected to the gate of the NMOS component Q104. The gates of the NMOS components Q105 and Q106 of the switching unit 21 receive the control signal CONTROL outputted from the source of the NMOS component Q104. One end of the resistance component R823 is connected to the power (+5V), the other end of the resistance component R823 is connected to the source of the NMOS component Q104 and one end of the capacitance component C1217 respectively. Both the other end of the capacitance component C1217 and the drains of the NMOS components Q104 and Q107 are grounded.

The principles of the circuitry of the present invention when switching on/off the notebook computer (for example, pressing a power button) are illustrated with FIG. 2C. FIG. 2C is a schematic view of the relationships between a trigger signal (PCI_RESET), a control signal (CONTROL), an audio signal (AUDIO_L/AUDIO_R), an audio output signal (AUDIO_L_OUT/AUDIO_R_OUT), and the power on/off signal (POWER) of the notebook computer shown in FIG. 2B.

Referring to FIG. 2C, the user's switching on the power of the notebook computer affects the power on/off signal (POWER) in the way that a conversion from low potential (the first level) to high potential (the second level) happens to the power on/off signal POWER, so as to switch on the power. At this point, the audio signal (AUDIO_L/AUDIO_R) does output an audio jump signal in the presence of the blocking capacitors. When a specific period of time (T1, or 10 ms in this embodiment) has passed, a conversion from low potential to high potential happens to the trigger signal (PCI_RESET) so as to switch on the NMOS component Q107, but the NMOS component Q104 is switched off because the gate of the NMOS component Q104 receives a low-potential signal (from the source of the NMOS component Q107). Hence, upon completion of the charging of the capacitance component C1217 by the resistance component R823, a conversion from low potential to high potential happens to the control signal CONTROL (outputted by the source of the NMOS component Q104) received by the switching unit 21, thus switching on the NMOS components Q105 and Q106 and electrically connecting the audio signal (AUDIO_L/AUDIO_R) to the audio device 11. Considering the relatively long duration of the audio jump signal generated by the audio signal, this embodiment provides the delay circuit 221 comprising both the resistance component R823 and the capacitance component C1217. The delay circuit 221 delays switching on the NMOS components Q105 and Q106. On the other hand, the charging time T2 (T2 is 1 s in this embodiment) the resistance component R823 takes to charge the capacitance component C1217 has to be greater than the duration of the audio jump signal. In other words, electrically connecting the audio signal (AUDIO_L/AUDIO_R) to the audio device 11 when the power has been switched on for a period of time (T1+T2) prevents the audio jump signal which may otherwise be generated the moment the power is switched on, as illustrated with an audio output signal (AUDIO_L_OUT/AUDIO_R_OUT) shown in FIG. 2C.

By contrast, the user's switching off the power of the notebook computer affects the trigger signal (PCI_RESET) in the way that a conversion from high potential to low potential happens to the trigger signal, so as to switch off the NMOS component Q107. At this point, the NMOS component Q104 is switched on because the gate of the NMOS component Q104 receives a high-potential signal (from the source of the NMOS component Q107). Hence, a conversion from high potential to low potential happens to the control signal CONTROL (outputted by the source of the NMOS component Q104) received by the switching unit 21 and thereby switches off the NMOS components Q105 and Q106 and electrically disconnecting the audio signal (AUDIO_L/AUDIO_R) from the audio device 11. Furthermore, when a conversion from high potential to low potential has happened to the trigger signal (PCI_RESET) for a specific period of time (T1, or 10 ms in this embodiment), a conversion from high potential to low potential happens to the power on/off signal (POWER) so as to switch off the power. At this point, the audio signal (AUDIO_L/AUDIO_R) does output an audio jump signal in the presence of the blocking capacitors. In other words, electrically disconnecting the audio signal (AUDIO_L/AUDIO_R) from the audio device 11 a period of time (T1) before the power is switched off prevents the audio jump signal which may otherwise be generated the moment the power is switched off, as illustrated with an audio output signal (AUDIO_L_OUT/AUDIO_R_OUT) shown in FIG. 2C.

All the MOS components shown in the circuit of this embodiment belong to n-channel metal oxide semiconductor (NMOS) components triggered and switched on using a high-level signal, but may optionally be replaced with p-channel metal oxide semiconductor (PMOS) components or a combination of NMOS and PMOS components and the circuit may be modified accordingly.

In short, the present invention discloses the audio device protection system which comprises the control unit for converting the trigger signal to the control signal. During the startup/shutdown procedure, the trigger signal lags/leads the power on/off signal in changing from the first/second level to the second/first level. As a result, the switching unit enables/disables the electrical connection between the audio signal and the audio device, thus controlling timing of delivery of the electronic device-outputted audio signal to the audio device during the startup/shutdown procedure of the electronic device. In other words, electrically connecting the audio signal to the audio device after having switched on the power for a period of time. Conversely, electrically disconnecting the audio signal from the audio device before switching off the power. Accordingly, the present invention prevents an audio jump signal (audio noise) which may otherwise be outputted by an audio signal of an electronic device because of instantaneous charging/discharging of blocking capacitors when the power of the electronic device is switched on/off. The audio jump signal, if existed, would instantaneously trigger or shut down the audio device to the detriment thereof. Insomuch as the present invention prevents the audio jump signal which may otherwise be outputted by the audio signal when the power of the electronic device is switched on/off, the audio device does not produce audio noise, for example, pop noise, thus the user is not annoyed or dissatisfied with any audio noise.

The foregoing specific embodiment is only illustrative of the features and functions of the present invention but are not intended to restrict the scope of the present invention. It is apparent to those skilled in the art that all modifications and variations made in the foregoing embodiment according to the spirit and principle in the disclosure of the present invention should fall within the scope of the appended claims.

What is claimed is:

1. An audio device protection system for use in an electronic device electrically connected to an audio device, wherein the electronic device outputs an audio signal, a power on/off signal, and a trigger signal, the audio signal allowing the audio device to operate, the trigger signal lagging the power on/off signal in changing from a first level to a second level different from the first level during a startup procedure of the electronic device, the trigger signal leading the power on/off signal in changing from the second level to the first level during a shutdown procedure of the electronic device, the audio device protection system comprising:
a switching unit electrically connected to the audio signal of the electronic device and the audio device and configured to enable/disable electrical connection therebetween; and
a control unit electrically connected to the trigger signal of the electronic device and the switching unit and configured to output, upon receipt of the trigger signal outputted by the electronic device during the startup/shutdown procedure thereof, a control signal to the switching unit so as to allow the switching unit to enable/disable the electrical connection between the audio signal of the electronic device and the audio device, thus controlling timing of delivery of the electronic device-outputted audio signal to the audio device during the startup/shutdown procedure of the electronic device.

2. The audio device protection system of claim 1, wherein the electronic device comprises a notebook computer.

3. The audio device protection system of claim 1, wherein the first level is a low potential, while the second level is a high potential.

4. The audio device protection system of claim 1, wherein the trigger signal comprises a signal PCI_RESET outputted by chips of the electronic device.

5. The audio device protection system of claim 1, wherein the switching unit comprises a metal oxide semiconductor (MOS) component.

6. The audio device protection system of claim 1, wherein the control unit comprises a MOS component.

7. The audio device protection system of claim 6, wherein the control unit further comprises a delay circuit comprising a resistance component and a capacitance component, the delay circuit delays the control signal for a period of time relative to the trigger signal.

8. The audio device protection system of claim 7, wherein a delay caused by the delay circuit takes as much time as charging of the resistance component and the capacitance component does.

9. The audio device protection system of claim 1, wherein the control unit further comprises a delay circuit comprising a resistance component and a capacitance component, the delay circuit delays the control signal for a period of time relative to the trigger signal.

10. The audio device protection system of claim 9, wherein a delay caused by the delay circuit takes as much time as charging of the resistance component and the capacitance component does.
